(19) United States
(12) Patent Application Publication
(10) Pub. No.: US 2026/0036694 A1
(43) Pub. Date: Feb. 5, 2026

(54) DEPTH IMAGE SENSING DEVICE AND OPERATION METHOD THEREOF

(71) Applicant: SK hynix Inc., Icheon-si Gyeonggi-do (KR)

(72) Inventor: Ji Hee HAN, Icheon-si Gyeonggi-do (KR)

(73) Assignee: SK hynix Inc., Icheon-si Gyeonggi-do (KR)

(21) Appl. No.: 19/285,703

(22) Filed: Jul. 30, 2025

(30) Foreign Application Priority Data
Jul. 31, 2024 (KR) 10-2024-0102056

(51) Int. Cl. G01S 17/10; G01S 17/89; H04N 25/773

(52) U.S. Cl. CPC G01S 17/10; G01S 17/89; H04N 25/773

(57) ABSTRACT

An operation method of a depth image sensing device includes obtaining a first peak bin number from a first histogram generated by using a first single photon avalanche diode (SPAD) pixel included in a unit pixel and a time-to-digital converter (TDC). The method also includes obtaining a second peak bin number from a second histogram generated by using a second SPAD pixel included in the unit pixel and the TDC. The method further includes obtaining a third peak bin number from a third histogram generated by using a third SPAD pixel included in the unit pixel and the TDC. The method additionally includes calibrating the TDC by adjusting at least one of the first peak bin number, the second peak bin number, and the third peak bin number.

### CROSS-REFERENCE TO RELATED APPLICATION

The present application claims priority under 35 U.S.C. § 119 (a) to Korean Patent Application No. 10-2024-0102056, filed in the Korean Intellectual Property Office on Jul. 31, 2024, the entire contents of which application is incorporated herein by reference.

### TECHNICAL FIELD

The present disclosure relates to a depth image sensing device capable of processing data related to depth and an operation method thereof.

### BACKGROUND

An image sensing device is a device for capturing an optical image by using a photosensitive semiconductor material which reacts to light. With the development of automotive, medical, computer, and communication industries, the demand for a high-performance image sensing device is increasing in various fields. For example, a high-performance image sensing device would improve devices such as a smartphone, a digital camera, a game machine, an IoT (Internet of Things), a robot, a security camera, and a medical micro camera.

The image sensing device may be used to obtain a depth image based on a time of flight (ToF) of emitted laser pulses. As depth measurement technology is capable of being used in various technical fields, there is a need to develop an image sensing device with high depth accuracy.

### SUMMARY

Embodiments of present disclosure may solve the above-mentioned problems occurring in the prior art while advantages achieved by the prior art are maintained intact.

An embodiment of the present disclosure may provide a method and a device which calibrate a time-to-digital converter (TDC).

An embodiment of the present disclosure may provide a method and a device which measure a depth in consideration of a variation in single photon avalanche diode (SPAD) pixels constituting a unit pixel.

An embodiment of the present disclosure may provide a method and a device which unify peak bin numbers capable of being obtained from a histogram associated with SPAD pixels included in the same unit pixel.

An embodiment of the present disclosure may provide a method and a device which increase depth accuracy.

The technical problems to be solved by the present disclosure are not limited to the aforementioned problems, and any other technical problems not mentioned herein will be understood from the following description by those skilled in the art to which the present disclosure pertains.

According to an embodiment, an operation method of a depth image sensing device may include obtaining a first peak bin number from a first histogram generated by using a first single photon avalanche diode (SPAD) pixel included in a unit pixel and a time-to-digital converter (TDC), obtaining a second peak bin number from a second histogram generated by using a second SPAD pixel included in the unit pixel and the TDC, obtaining a third peak bin number from a third histogram generated by using a third SPAD pixel included in the unit pixel and the TDC, and calibrating the TDC by adjusting at least one of the first peak bin number, the second peak bin number, and the third peak bin number.

According to an embodiment, calibrating the TDC may include determining a target bin number based on the first peak bin number, the second peak bin number, and the third peak bin number, and calculating the TDC by adjusting one or more of the first peak bin number, the second peak bin number, and the third peak bin number based on the target bin number.

According to an embodiment, determining the target bin number may include determining, as the target bin number, a peak bin number of a histogram corresponding to a ratio being the greatest from among a first ratio of a peak value of the first histogram to a sum of count values of the first histogram, a second ratio of a peak value of the second histogram to a sum of count values of the second histogram, and a third ratio of a peak value of the third histogram to a sum of count values of the third histogram.

According to an embodiment, determining the target bin number may include determining the greatest peak bin number from among the first peak bin number, the second peak bin number, and the third peak bin number as the target bin number.

According to an embodiment, determining the target bin number may include determining the lowest peak bin number from among the first peak bin number, the second peak bin number, and the third peak bin number as the target bin number.

According to an embodiment, determining the target bin number may include obtaining ground truth information about a depth, and determining a number of a bin, which should have a peak value in a histogram, as the target bin number, based on the ground truth information.

According to an embodiment, calibrating the TD may include calibrating the TDC by adjusting one or more of the first peak bin number, the second peak bin number, and the third peak bin number such that the first peak bin number, the second peak bin number, and the third peak bin number are equal to the target bin number.

According to an embodiment, calibrating the TD may include generating calibration values to be used to adjust peak bin numbers based on the target bin number, and calibrating the TDC by adjusting one or more of the first peak bin number, the second peak bin number, and the third peak bin number based on the calibration values.

According to an embodiment, generating the calibration values may include obtaining an adjustment unit value being a unit value for adjusting the peak bin numbers, generating first calibration values by subtracting each of the first peak bin number, the second peak bin number, and the third peak bin number from the target bin number, generating second calibration values by dividing the first calibration values by the adjustment unit value and removing decimals of result values of the division, and generating third calibration values by multiplying the second calibration values and the adjustment unit value together.

According to an embodiment, calibrating the TD may include calibrating the TDC by generating adjusted peak bin numbers by adding the third calibration values to the first peak bin number, the second peak bin number, and the third peak bin number.

According to an embodiment, obtaining the first peak bin number may include generating the first histogram in which a count value of laser pulses detected by the first SPAD pixel is used as a y-axis and bin numbers corresponding to a time of flight (ToF) of the laser pulses are used as an x-axis.

According to an embodiment, generating the first histogram may include generating a coarse histogram in which the count value of the laser pulses is used as the y-axis and the bin numbers corresponding to the ToF of the laser pulses are used as the x-axis, and generating the first histogram being a fine histogram by dividing an interval from a first bin number being a number of a bin having a peak value in the coarse histogram to a second bin number being a next number of the first bin number into given sections.

According to an embodiment, each of the first peak bin number, the second peak bin number, and the third peak bin number may be a number of a bin having a peak value in each of the first histogram, the second histogram, and the third histogram, respectively.

According to an example embodiment of the present disclosure, an operation method of a depth image sensing device may include generating a first histogram based on a count value of first laser pulses detected by a first single photon avalanche diode (SPAD) pixel included in a unit pixel and a time of flight (ToF) of the first laser pulses, generating a second histogram based on a count value of second laser pulses detected by a second SPAD pixel included in the unit pixel and a ToF of the second laser pulses, generating a third histogram based on a count value of third laser pulses detected by a third SPAD pixel included in the unit pixel and a ToF of the third laser pulses, and calibrating a time-to-digital converter (TDC) by adjusting at least one of a first peak bin number being a number of a bin having a peak count value in the first histogram, a second peak bin number being a number of a bin having a peak count value in the second histogram, and a third peak bin number being a number of a bin having a peak count value in the third histogram.

According to an embodiment, the calibrating of the TD may include determining a target bin number based on the first peak bin number, the second peak bin number, and the third peak bin number, and calculating the TDC by adjusting at least one of the first peak bin number, the second peak bin number, and the third peak bin number based on the target bin number.

According to an embodiment, the determining of the target bin number may include determining, as the target bin number, a peak bin number of a histogram corresponding to a ratio being the greatest from among a first ratio of a peak value of the first histogram to a sum of count values of the first histogram, a second ratio of a peak value of the second histogram to a sum of count values of the second histogram, and a third ratio of a peak value of the third histogram to a sum of count values of the third histogram.

According to embodiment, the determining of the target bin number may include determining the greatest peak bin number from among the first peak bin number, the second peak bin number, and the third peak bin number as the target bin number.

According to an embodiment, the determining of the target bin number may include determining the lowest peak bin number from among the first peak bin number, the second peak bin number, and the third peak bin number as the target bin number.

According to an embodiment, the determining of the target bin number may include obtaining ground truth information about a depth, and determining a number of a bin, which should have a peak value in a histogram, as the target bin number, based on the ground truth information.

According to an embodiment, the calibrating of the TD may include generating calibration values to be used to adjust peak bin numbers based on the target bin number, and calibrating the TDC by adjusting at least one of the first peak bin number, the second peak bin number, and the third peak bin number based on the calibration values.

According to an embodiment, the generating of the calibration values may include obtaining an adjustment unit value being a unit value adjusting the peak bin numbers, generating first calibration values by subtracting each of the first peak bin number, the second peak bin number, and the third peak bin number from target bin number, generating second calibration values by dividing the first calibration values by the adjustment unit value and removing decimals of result values of the division, and generating third calibration values by multiplying the second calibration values and the adjustment unit value together, and the calibrating of the TD may include calibrating the TDC by generating adjusted peak bin numbers by adding the third calibration values to the first peak bin number, the second peak bin number, and the third peak bin number.

According to an embodiment, the calibrating of the TD may include calibrating the TDC by adjusting at least one of the first peak bin number, the second peak bin number, and the third peak bin number such that the first peak bin number, the second peak bin number, and the third peak bin number are equal to the target bin number.

According to an example embodiment of the present disclosure, a depth image sensing device may include a pixel array that includes a unit pixel including a first single photon avalanche diode (SPAD) pixel, a second SPAD pixel, and a third SPAD pixel, a time-to-digital converter (TDC) that digitizes a time of flight (ToF) of laser pulses detected by the first SPAD pixel, the second SPAD pixel, and the third SPAD pixel and generates a first histogram associated with the first SPAD pixel, a second histogram associated with the second SPAD pixel, and a third histogram associated with the third SPAD pixel, based the ToF of the laser pulses and count values of the laser pulses, and a processing unit that calibrates the TDC by adjusting at least one of a first peak bin number being a number of a bin having a peak count value in the first histogram, a second peak bin number being a number of a bin having a peak count value in the second histogram, and a third peak bin number being a number of a bin having a peak count value in the third histogram.

Features briefly summarized above are merely possible aspects of the present disclosure and do not limit the scope of the present disclosure.

### BRIEF DESCRIPTION OF THE DRAWINGS

The above and other objects, features, and advantages of the present disclosure will be more apparent from the following detailed description taken in conjunction with the accompanying drawings:

FIG. 1 is a flowchart for describing an operation method of a depth image sensing device according to an example embodiment of the present disclosure;

FIG. 2A is a diagram illustrating a histogram according to an example embodiment of the present disclosure;

FIG. 2B is a diagram illustrating a histogram according to an example embodiment of the present disclosure;

FIG. 2C is a diagram illustrating a histogram according to an example embodiment of the present disclosure;

FIG. 2D is a diagram illustrating a histogram according to an example embodiment of the present disclosure;

FIG. 3 is a flowchart for describing an operation method of a depth image sensing device according to an example embodiment of the present disclosure;

FIG. 4 is a flowchart for describing an operation method of a depth image sensing device according to an example embodiment of the present disclosure;

FIG. 5A is a diagram for describing an operation method of a depth image sensing device according to an example embodiment of the present disclosure;

FIG. 5B is a diagram for describing an operation method of a depth image sensing device according to an example embodiment of the present disclosure;

FIG. 6 is a flowchart for describing an operation method of a depth image sensing device according to an example embodiment of the present disclosure;

FIG. 7 is a block diagram of a depth image sensing device according to an example embodiment of the present disclosure; and

FIG. 8 is a block diagram of a calibration unit according to an example embodiment of the present disclosure.

### DETAILED DESCRIPTION

Hereinafter, some embodiments of the present disclosure are described with reference to the accompanying drawings to such an extent as to be understood by one skilled in the art. However, the present disclosure may be implemented in several different forms and is not limited to embodiments described herein.

In describing example embodiments of the present disclosure, when it is determined that a detailed description of a well-known configuration or function may obscure the gist of the present disclosure, the detailed description thereof is omitted. Parts not related to the description of the present disclosure are omitted from the drawings, and similar parts are denoted by similar reference numbers or labels throughout the specification.

In the present disclosure, when one component is referred to as “connected with” or “coupled to” another component, it includes not only the case where the components are directly connected but also the case where the components are indirectly connected with another component interposed therebetween. In addition, when one component is referred to as “comprising,” “including,” or “having” another component, it is meant that the component may further include any other components without excluding other components as long as there is no contrary description.

In the present disclosure, terms such as “first” and “second” are used only for the purpose of distinguishing one component from another component, and not to imply a number, an order, or importance of components unless specifically stated. Accordingly, a first component according to an embodiment may be referred to as a second component according to another embodiment in the scope of the present disclosure. Likewise, a second component according to an embodiment may be referred to as a first component according to another embodiment.

In the present disclosure, components which are distinguished from each other are only for clearly explaining each feature, and that the components are distinguished from each other does not necessarily mean that the components are separated from each other. That is, a plurality of components may be integrated to form a single hardware or software unit, or a single component may be distributed to form a plurality of hardware or software units. Accordingly, even though not specifically mentioned, an embodiment in which components are integrated or a single component is distributed is also included in the scope of the present disclosure.

In the present disclosure, components which are described in various embodiments might not necessarily refer to essential components, and d some thereof may be selective components. Accordingly, an embodiment which is implemented with a subset of components described in an embodiment is also included in the scope of the present disclosure. Also, an embodiment which additionally includes any other components in addition to components described in various embodiments is also included in the scope of the present disclosure.

In the present disclosure, expressions of positional relationships used in the specification, for example, a top, a bottom, a left side, and a right side are described for convenience of description. When viewing the drawings illustrated in the specification in reverse, the positional relationships described in the specification may be interpreted in the opposite way.

In the present disclosure, each of such phrases as “A or B,” “at least one of A and B,” “at least one of A or B,” “A, B, or C,” “at least one of A, B, and C,” and “at least one of A, B, or C” may include any one of items listed together with the corresponding phase among the phases or all possible combinations thereof.

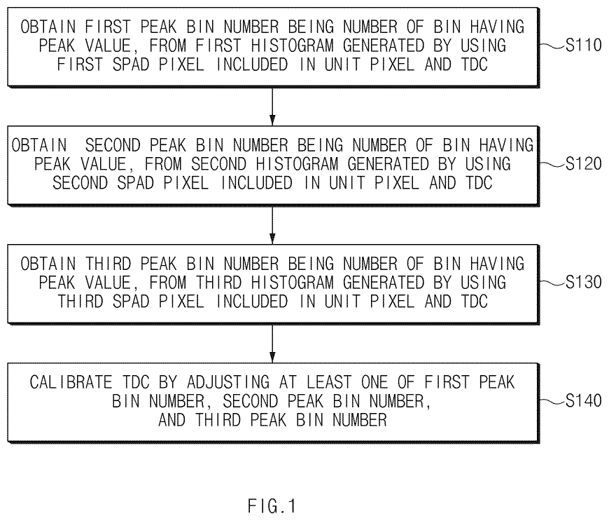

Below, example embodiments of the present disclosure are described in detail with reference to FIGS. 1 to 7.

FIG. 1 is a flowchart for describing an operation method of a depth image sensing device according to an example embodiment of the present disclosure.

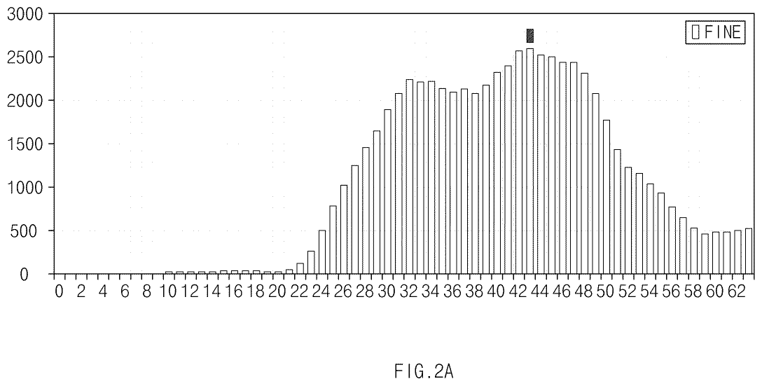

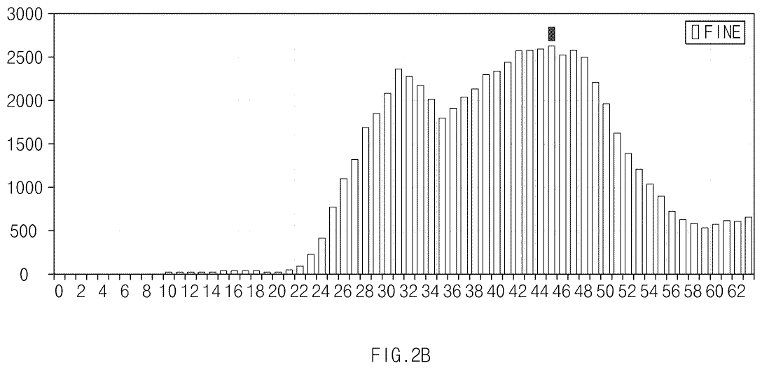

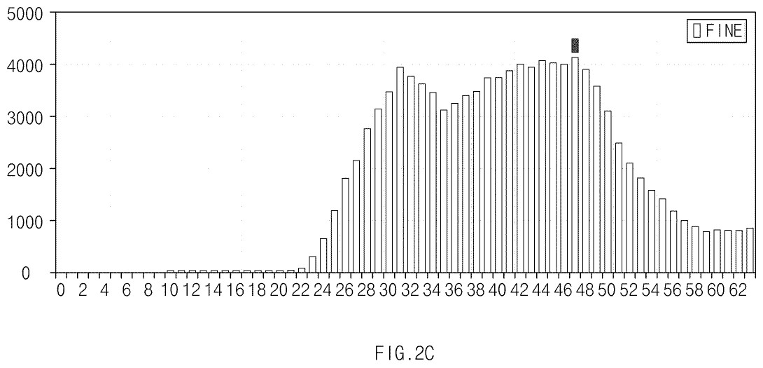

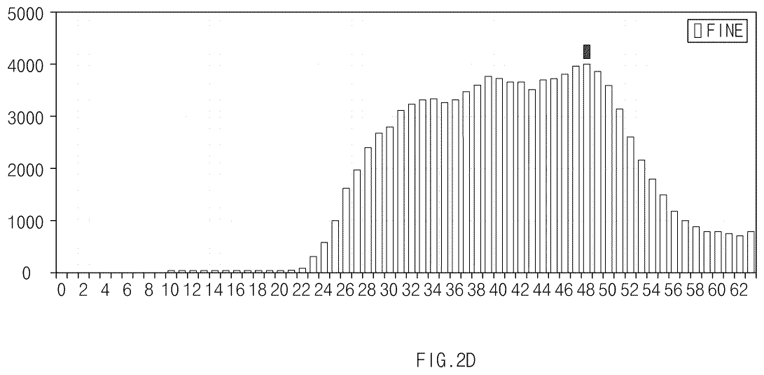

FIGS. 2A to 2D are diagrams illustrating histograms according to an example embodiment of the present disclosure. Below, FIG. 1 will be described with reference to FIGS. 2A to 2D.

Referring to FIG. 1, at S110, an operation method of a depth image sensing device according to an example embodiment of the present disclosure may obtain a first peak bin number being a number of a bin having a peak value, from a first histogram generated by using a first single photon avalanche diode (SPAD) pixel included in a unit pixel and a time-to-digital converter (TDC).

The depth image sensing device according to an example embodiment of the present disclosure may emit laser pulses to an object through a light source. Also, the depth image sensing device may detect laser pulses reflected by the object through a pixel array. The pixel array may include unit pixels, each of which may include a plurality of SPAD pixels. For example, the unit pixel may include the SPAD pixels of 2×2, but the present disclosure is not limited thereto.

The depth image sensing device may measure a distance from the depth image sensing device to the object by measuring a time of flight (ToF) of the laser pulses detected by the SPAD pixels. To measure the distance from the depth image sensing device to the object, the TDC may digitize the ToF of the laser pulses and may generate a histogram based on count values of the laser pulses for each ToF.

The depth image sensing device may obtain a peak bin number being the number of a bin having a peak, or highest, value from the histogram. For example, referring to FIG. 2A, assuming that a histogram of FIG. 2A is the first histogram, a first peak bin number being the number of a bin having a peak value in the first histogram may be 43.

At S120, the operation method of the depth image sensing device may obtain a second peak bin number being the number of a bin having a peak value, from a second histogram generated by using a second SPAD pixel included in the unit pixel and the TDC. For example, referring to FIG. 2B, assuming that a histogram of FIG. 2B is the second histogram, a second peak bin number being a number of a bin having a peak value in the second histogram may be 45.

At S130, the operation method of the depth image sensing device may obtain a third peak bin number being a number of a bin having a peak value, from a third histogram generated by using a third SPAD pixel included in the unit pixel and the TDC. For example, referring to FIG. 2C, assuming that a histogram of FIG. 2C is the third histogram, a third peak bin number being a number of a bin having a peak value in the third histogram may be 47.

A peak bin number may be a bin number which is used when a depth is calculated. For example, referring to FIG. 2A, the depth image sensing device may calculate a depth based on a ToF value corresponding to 43 being the first peak bin number.

At S140, the operation method of the depth image sensing device may calibrate the TDC by adjusting at least one of the first peak bin number, the second peak bin number, and the third peak bin number. The calibration of the TDC may mean that at least some of the first peak bin number, the second peak bin number, and the third peak bin number have values different from existing values. For convenience of description, the expression is given as when TDC calibration is performed, at least one of the first peak bin number, the second peak bin number, and the third peak bin number have values different from existing values, but the number of peak bin numbers targeted for change is not limited. For example, the case where at least one of the first peak bin number and the second peak bin number has a value different from an existing value may also refer to “TDC calibration.”

When a laser pulse is irradiated on a flat object having the same depth, the depth image sensing device should determine that the entire object has the same depth. However, due to the variation in the SPAD pixels, different depths may be measured with respect to the object. The variation in the SPAD pixels may come from a layout issue of TDC clock generator logic. For example, the variation in the SPAD pixels may be caused by the spatial variation due to a difference between distances of the TDC clock generator logic and TDCs (e.g., a difference between a distance between the TDC clock generator logic and a first TDC and a distance between the TDC clock generator logic and a second TDC). In general, the SPAD pixels included in the same unit pixel should have the same peak bin number. However, the SPAD pixels included in the same unit pixel may have peak bin numbers (e.g., the first peak bin number, the second peak bin number, and the third peak bin number) due to the variation in the SPAD pixels. Accordingly, there may be a need to calibrate the TDC by adjusting at least one of the first peak bin number, the second peak bin number, and the third peak bin number. For example, the operation method of the depth image sensing device may unify the first peak bin number, the second peak bin number, and the third peak bin number. In detail, the operation method of the depth image sensing device may determine a target bin number based on the first peak bin number, the second peak bin number, and the third peak bin number and may adjust the first peak bin number, the second peak bin number, and the third peak bin number based on the target bin number. Also, the operation method of the depth image sensing device may adjust at least one of the first peak bin number, the second peak bin number, and the third peak bin number such that the first peak bin number, the second peak bin number, and the third peak bin number are equal to the target bin number. The operation method of the depth image sensing device may increase depth accuracy by unifying peak bin number values respectively associated with the SPAD pixels included in the same unit pixel. How to calibrate the TDC by using peak bin numbers which the SPAD pixels included in the same unit pixel have is described in detail later in accordance with an embodiment.

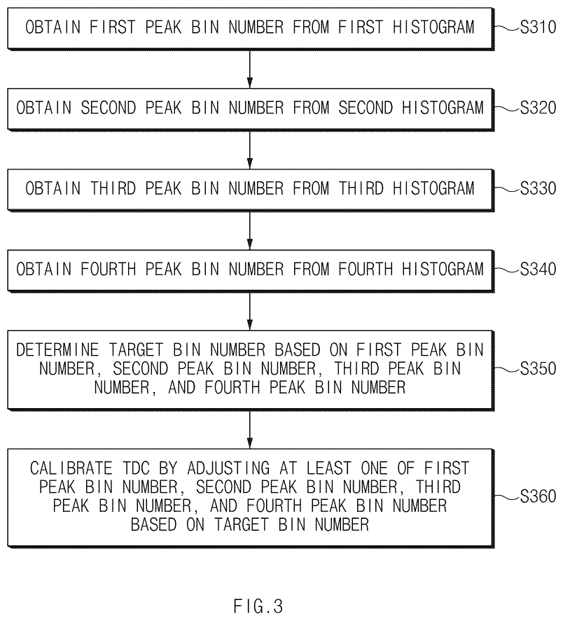

FIG. 3 is a flowchart for describing an operation method of a depth image sensing device according to an example embodiment of the present disclosure. Below, FIG. 3 is described with reference to FIGS. 2A to 2D.

Referring to FIG. 3, at S310, the operation method of the depth image sensing device may obtain the first peak bin number from the first histogram. In detail, the operation method of the depth image sensing device may obtain the first peak bin number from the first histogram generated by using the first SPAD pixel included in the unit pixel and the TDC. For example, assuming that the histogram of FIG. 2A is the first histogram, the operation method of the depth image sensing device may obtain 43 as the first peak bin number.

At S320, the operation method of the depth image sensing device may obtain the second peak bin number from the second histogram. In detail, the operation method of the depth image sensing device may obtain the second peak bin number from the second histogram generated by using the second SPAD pixel included in the unit pixel and the TDC. For example, assuming that the histogram of FIG. 2B is the second histogram, the operation method of the depth image sensing device may obtain 45 as the second peak bin number.

At S330, the operation method of the depth image sensing device may obtain the third peak bin number from the third histogram. In detail, the operation method of the depth image sensing device may obtain the third peak bin number from the third histogram generated by using the third SPAD pixel included in the unit pixel and the TDC. For example, assuming that the histogram of FIG. 2C is the third histogram, the operation method of the depth image sensing device may obtain 47 as the third peak bin number.

At S340, the operation method of the depth image sensing device may obtain a fourth peak bin number from a fourth histogram. In detail, the operation method of the depth image sensing device may obtain the fourth peak bin number from the fourth histogram generated by using a fourth SPAD pixel included in the unit pixel and the TDC. For example, assuming that the histogram of FIG. 2D is the fourth histogram, the operation method of the depth image sensing device may obtain 48 as the fourth peak bin number.

As described above, the first to fourth SPAD pixels included in the same unit pixel should have the same peak bin numbers but may have different peak bin numbers as described above due to the variation in the SPAD pixels. To increase depth accuracy, at S140, the operation method of the depth image sensing device may calibrate the TDC by adjusting at least one of the first peak bin number, the second peak bin number, the third peak bin number, and the fourth peak bin number.

For example, at S350, the operation method of the depth image sensing device may determine a target bin number based on the first peak bin number, the second peak bin number, the third peak bin number, and the fourth peak bin number.

In detail, the depth image sensing device may determine, as the target bin number, a peak bin number of a histogram corresponding to the greatest ratio among a first ratio of the peak value of the first histogram to the sum of the count values of the first histogram, a second ratio of the peak value of the second histogram to the sum of the count values of the second histogram, a third ratio of the peak value of the third histogram to the sum of the count values of the third histogram, and a fourth ratio of the peak value of the fourth histogram to the sum of the count values of the fourth histogram. For example, the sum of the number of laser pulses counted in the first histogram may be 64648. Also, a peak value of the number of laser pulses counted for each bin number in the first histogram may be 2598. According to the above description, the first ratio may be 2598/64648, that is, about 0.040.

Also, the sum of the number of laser pulses counted in the second histogram may be 67105. In addition, a peak value of the number of laser pulses counted for each bin number in the second histogram may be 2627. According to the above description, the second ratio may be 2627/67105, that is, about 0.039.

Also, the sum of the number of laser pulses counted in the third histogram may be 105959. In addition, a peak value of the number of laser pulses counted for each bin number in the third histogram may be 4107. According to the above description, the third ratio may be 4107/105959, that is, about 0.038.

Also, the sum of the number of laser pulses counted in the fourth histogram may be 102311. In addition, the peak value of the number of laser pulses counted in the fourth histogram may be 3972. According to the above description, the fourth ratio may be 3972/102311, that is, about 0.038.

Accordingly, the operation method of the depth image sensing device may determine, as the target bin number, the first peak bin number of the first histogram corresponding to the first ratio, which is the greatest, from among the first ratio, the second ratio, the third ratio, and the fourth ratio. That is, the target bin number may be 43.

The method of determining a target bin number based on a ratio of a peak value of a histogram to the sum of count values of the histogram may be referred to as a “first target bin number determining method.” As an example, in the first target bin number determining method, the description is given as the target bin number is determined based on the first to fourth peak bin numbers. However, the number of peak bin numbers may be less than 4 or may be greater than 4. Also, the above numerical values are examples for convenience of description, and the operation method of the depth image sensing device is not limited to the above description.

As another example, the operation method of the depth image sensing device may determine, as the target bin number, the lowest peak bin number from among the first peak bin number, the second peak bin number, the third peak bin number, and the fourth peak bin number. For example, in the above example, the first peak bin number may be 43, the second peak bin number may be 45, the third peak bin number may be 47, and the fourth peak bin number may be 48; in this case, the target bin number may be 43.

A method of determining the lowest peak bin number from among peak bin numbers as a target peak bin number may be referred to as a “second target bin number determining method.” As an example, in the second target bin number determining method, the description is given as the target bin number is determined based on the first to fourth peak bin numbers. However, the number of peak bin numbers may be less than 4 or may be greater than 4.

As another example, the operation method of the depth image sensing device may determine, as the target bin number, the greatest peak bin number from among the first peak bin number, the second peak bin number, the third peak bin number, and the fourth peak bin number. For example, in the above example, the first peak bin number may be 43, the second peak bin number may be 45, the third peak bin number may be 47, and the fourth peak bin number may be 48; in this case, the target bin number may be 48.

A method of determining a peak bin number being the greatest from among peak bin numbers as a target peak bin number may be referred to as a “third target bin number determining method.” As an example, in the third target bin number determining method, the description is given as the target bin number is determined based on the first to fourth peak bin numbers. However, the number of peak bin numbers may be less than 4 or may be greater than 4.

As another example, the operation method of the depth image sensing device may obtain ground truth information about a depth and may determine a number of a bin, which should have a peak value in a histogram, as a target bin number based on the ground truth information. For example, according to the ground truth information about the depth, the ToF measured by the depth image sensing device should have a specific value, in other words, the histogram should have a peak value at a specific peak bin number corresponding to the specific value, and thus, the specific peak bin number may be a target peak bin number. The method of determining the target peak bin number by using the ground truth information may be utilized to perform initial setting on the depth image sensing device in association with TDC calibration.

Also, at S360, the operation method of the depth image sensing device may calibrate the TDC by adjusting at least one of the first peak bin number, the second peak bin number, the third peak bin number, and the fourth peak bin number based on the target bin number.

In detail, the operation method of the depth image sensing device may calibrate the TDC by adjusting at least one of the first peak bin number, the second peak bin number, and the third peak bin number such that the first peak bin number, the second peak bin number, and the third peak bin number are equal to the target bin number. For example, when the target bin number is determined to 43, the first peak bin number already having a value of 43 may maintain the existing value, and the second peak bin number having a value of 45, the third peak bin number having a value of 47, and the fourth peak bin number having a value of 48 may all be adjusted to 43.

As another example, the operation method of the depth image sensing device may generate calibration values which are used to adjust peak bin numbers based on a target bin number. Also, the operation method of the depth image sensing device may calibrate the TDC by adjusting at least one of the first peak bin number, the second peak bin number, the third peak bin number, and the fourth peak bin number based on the calibration values. The method of calibrating the TDC by using a calibration value is described in detail later.

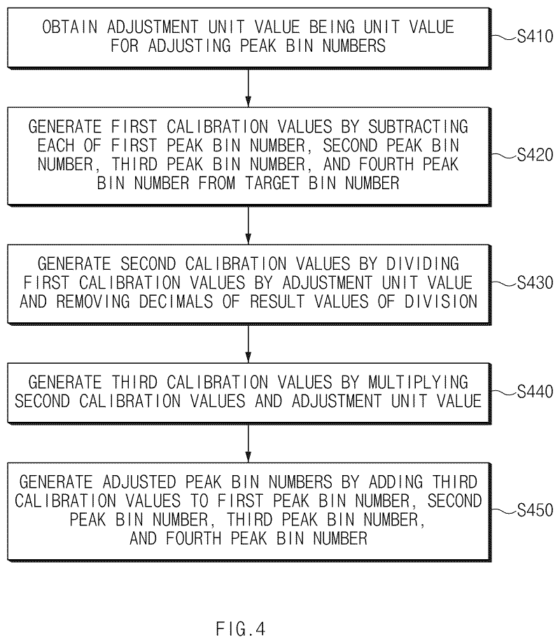

FIG. 4 is a flowchart for describing an operation method of a depth image sensing device according to an example embodiment of the present disclosure. In detail, FIG. 4 shows a flowchart associated with a method of calibrating the TDC by using a calibration value.

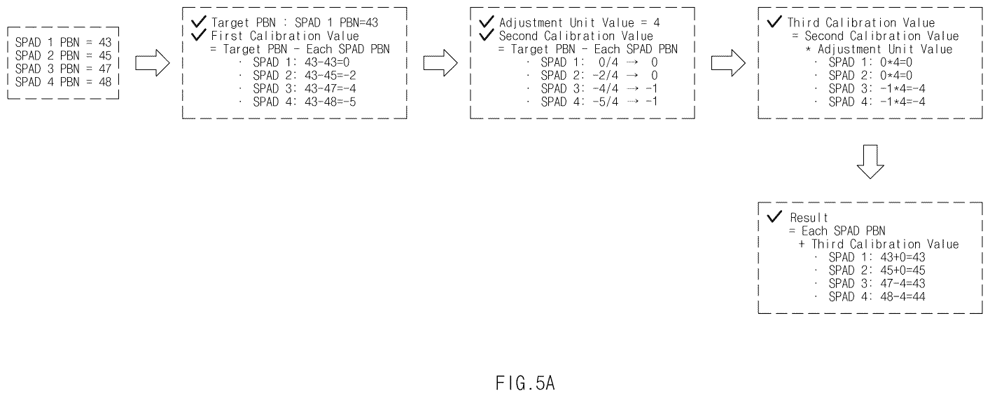

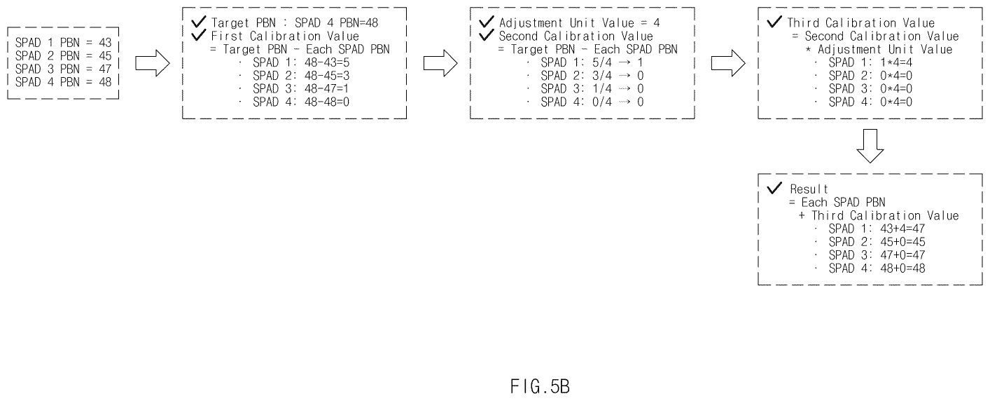

FIG. 5A is a diagram for describing an operation method of a depth image sensing device according to an example embodiment of the present disclosure.

FIG. 5B is a diagram for describing an operation method of a depth image sensing device according to an example embodiment of the present disclosure.

Below, FIG. 4 is described with reference to FIGS. 5A and 5B.

Referring to FIG. 4, at S410, an operation method of a depth image sensing device according to an example embodiment of the present disclosure may obtain an adjustment unit value being a unit value for adjusting peak bin numbers. For example, when the depth image sensing device adjusts a peak bin number, the depth image sensing device may adjust the peak bin number in units of 4, not in units of 1. In detail, assuming that the depth image sensing device adjusts a peak bin number under the condition that the peak bin number is 43, the depth image sensing device may adjust the peak bin number to a value obtained by adding or subtracting a multiple of 4, such as 35, 39, 47, and 51, in units of 4, not adjusting the peak bin number to 40, 41, 42, 44, 45, or 46 in units of 1. The adjustment unit value according to the above example may be 4, but the present disclosure is not limited thereto. When the adjustment unit value is greater than 1, the operation method of the depth image sensing device should obtain the adjustment unit value and should adjust the peak bin number by utilizing the calibration values.

In detail, at S420, the operation method of the depth image sensing device may generate first calibration values by subtracting each of the first peak bin number, the second peak bin number, the third peak bin number, and the fourth peak bin number from the target bin number. For example, referring to FIG. 5A, a first peak bin number SPAD 1 PBN associated with a first SPAD pixel SPAD 1 may be 43, a second peak bin number SPAD 2 PBN associated with a second SPAD pixel SPAD 2 may be 45, a third peak bin number SPAD 3 PBN associated with a third SPAD pixel SPAD 3 may be 47, and a fourth peak bin number SPAD 4 PBN associated with a fourth SPAD pixel SPAD 4 may be 48. Also, as determined by the first target bin number determining method and the second target bin number determining method described above, the target bin number may be 43. Accordingly, the first calibration value for the first SPAD pixel may be 0 (=43-43), the first calibration value for the second SPAD pixel may be −2 (=43−45), the first calibration value for the third SPAD pixel may be −4 (=43−47), and the first calibration value for the fourth SPAD pixel may be −5 (=43−48).

Also, at 430, the operation method of the depth image sensing device may generate second calibration values by dividing the first calibration values by the adjustment unit value and removing or truncating decimals of result values of the division. For example, referring to FIG. 5A, the adjustment unit value may be 4. Also, the second calibration value for the second SPAD pixel may be 0 being a value obtained by removing or truncating a decimal from −0.5 (=− 2/4). In addition, the second calibration value for the third SPAD pixel may be −1 being a value obtained by removing or truncating a decimal from −1 (=−4/4). Furthermore, the second calibration value for the fourth SPAD pixel may be −1 being a value obtained by removing or truncating a decimal from −1.25 (=− 5/4). However, because the first calibration value for the first SPAD pixel is 0, it may be impossible to divide the first calibration value by the adjustment unit value; in this case, the second calibration value may be determined as 0.

Also, at 440, the operation method of the depth image sensing device may generate third calibration values by multiplying the second calibration values and the adjustment unit value together. For example, referring to FIG. 5A, the third calibration value for the first SPAD pixel may be 0 (=0*4), the third calibration value for the second SPAD pixel may be 0 (=0*4), the third calibration value for the third SPAD pixel may be −4 (=−1*4), and the third calibration value for the fourth SPAD pixel may be −4 (=−1*4).

In addition, at S450, the operation method of the depth image sensing device may generate adjusted peak bin numbers by adding the third calibration values to the first peak bin number, the second peak bin number, the third peak bin number, and the fourth peak bin number. For example, referring to FIG. 5A, the adjusted peak bin number for the first SPAD pixel may be 43 (=43+0), the adjusted peak bin number for the second SPAD pixel may be 45 (=45+0), the adjusted peak bin number for the third SPAD pixel may be 43 (=47−4), and the adjusted peak bin number for the fourth SPAD pixel may be 44 (=48−4). According to the above description, compared to the peak bin numbers 43, 45, 47, and 48 before the adjustment to 43, 45, 43, and 44, the deviations of the adjusted peak bin numbers for the first to fourth SPAD pixels decrease. Accordingly, depth accuracy may be increased when the depth is calculated by using the adjusted peak bin number.

As another example, as determined by the third target bin number determining method, the target bin number may be 48. Accordingly, when the description given at S420 is applied, the first calibration value for the first SPAD pixel may be 5 (=48−43), the first calibration value for the second SPAD pixel may be 3 (=48−45), the first calibration value for the third SPAD pixel may be 1 (=48−47), and the first calibration value for the fourth SPAD pixel may be 0 (=48−48).

Also, when the adjustment unit value is 4 under the condition that the description given at S430 is applied, the second calibration value for the first SPAD pixel may be 1 being a value obtained by removing or truncating a decimal from 1.25 (= 5/4). Also, the second calibration value for the second SPAD pixel may be 0 being a value obtained by removing or truncating a decimal from 0.75 (=¾). Furthermore, the second calibration value for the third SPAD pixel may be 0 being a value obtained by removing or truncating a decimal from 0.25 (=¼). However, because the second calibration value for the fourth SPAD pixel is 0, it may be impossible to divide the second calibration value by the adjustment unit value; in this case, the second calibration value may be determined as 0.

Also, when the description given at S440 is applied, the third calibration value for the first SPAD pixel may be 4 (=1*4), the third calibration value for the second SPAD pixel may be 0 (=0*4), the third calibration value for the third SPAD pixel may be 0 (=0*4), and the third calibration value for the fourth SPAD pixel may be 0 (=0*4).

Also, when the description given at S450 is applied, the adjusted peak bin number for the first SPAD pixel may be 47 (=43+4), the adjusted peak bin number for the second SPAD pixel may be 45 (=45+0), the adjusted peak bin number for the third SPAD pixel may be 47 (=47+0), and the adjusted peak bin number for the fourth SPAD pixel may be 48 (=48+0). According to the above description, compared to the peak bin numbers 43, 45, 47, and 48 before the adjustment to 47, 45, 47, and 48, the deviations of the adjusted peak bin numbers for the first to fourth SPAD pixels decrease. Accordingly, depth accuracy may be increased when the depth is calculated by using the adjusted peak bin number.

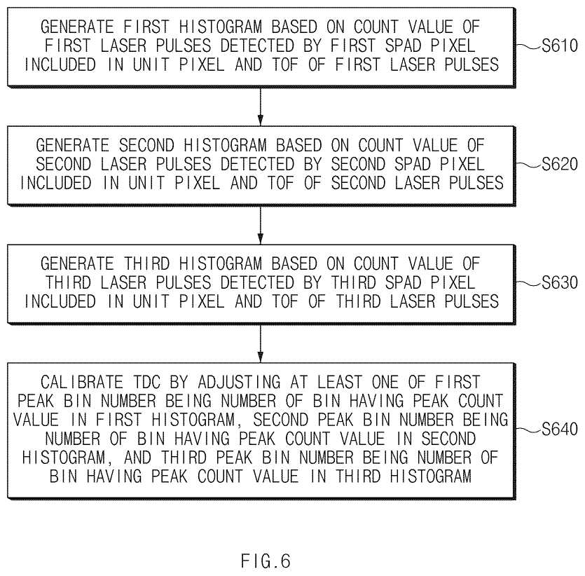

FIG. 6 is a flowchart for describing an operation method of a depth image sensing device according to an example embodiment of the present disclosure.

At S610, an operation method of a depth image sensing device according to an example embodiment of the present disclosure may generate a first histogram based on a count value of first laser pulses detected by a first SPAD pixel included in a unit pixel and a ToF of the first laser pulses. In detail, the operation method of the depth image sensing device may generate a first coarse histogram in which the count value of the first laser pulses is used as the y-axis and bin numbers corresponding to the ToF of the first laser pulses are used as the x-axis. Also, the operation method of the depth image sensing device may generate the first histogram being a fine histogram by dividing an interval from a first bin number being a number of a bin having a peak value in the first coarse histogram to a second bin number being a next number of the first bin number into given sections. For example, when a peak bin number in the first coarse histogram is 41, the operation method of the depth image sensing device may divide an interval from a bin number of 41 to a bin number of 42 into the given sections to generate the fine histogram. For example, the operation method of the depth image sensing device may generate the fine histogram by performing the division to have 64 bin numbers like FIGS. 2A to 2D.

At S620, the operation method of the depth image sensing device may generate a second histogram based on a count value of second laser pulses detected by a second SPAD pixel included in the unit pixel and a ToF of the second laser pulses. In detail, the operation method of the depth image sensing device may generate a second coarse histogram in which the count value of the second laser pulses is used as the y-axis and bin numbers corresponding to the ToF of the second laser pulses are used as the x-axis. Also, the operation method of the depth image sensing device may generate the second histogram being a fine histogram by dividing an interval from a first bin number being a number of a bin having a peak value in the second coarse histogram to a second bin number being a next number of the first bin number into the given sections. For example, when a peak bin number in the first coarse histogram is 43, the operation method of the depth image sensing device may divide an interval from a bin number of 43 to a bin number of 44 into the given sections to generate the fine histogram. For example, the operation method of the depth image sensing device may generate the fine histogram by performing the division to have 64 bin numbers like FIGS. 2A to 2D.

At S630, the operation method of the depth image sensing device may generate a third histogram based on a count value of third laser pulses detected by a third SPAD pixel included in the unit pixel and a ToF of the third laser pulses. In detail, the operation method of the depth image sensing device may generate a third coarse histogram in which the count value of the third laser pulses is used as the y-axis and bin numbers corresponding to the ToF of the third laser pulses are used as the x-axis. Also, the operation method of the depth image sensing device may generate the third histogram being a fine histogram by dividing an interval from a first bin number being a number of a bin having a peak value in the third coarse histogram to a second bin number being a next number of the first bin number into the given sections. For example, when a peak bin number in the third coarse histogram is 44, the operation method of the depth image sensing device may divide an interval from a bin number of 44 to a bin number of 45 into the given sections to generate the fine histogram. For example, the operation method of the depth image sensing device may generate the fine histogram by performing the division to have 64 bin numbers like FIGS. 2A to 2D.

At S640, the operation method of the depth image sensing device may calibrate the TDC by adjusting at least one of a first peak bin number being the number of the bin having the peak value in the first histogram, a second peak bin number being the number of the bin having the peak value in the second histogram, and a third peak bin number being the number of the bin having the peak value in the third histogram.

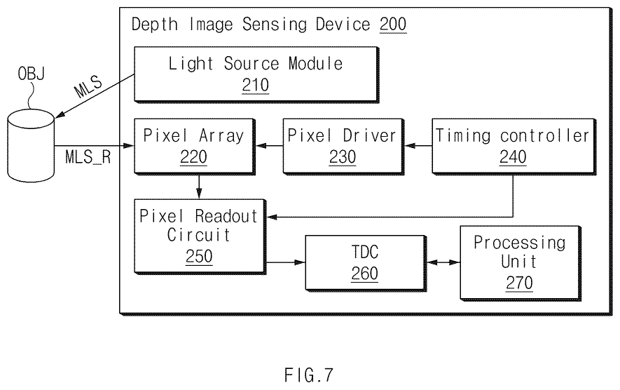

FIG. 7 is a block diagram of a depth image sensing device according to an example embodiment of the present disclosure.

Referring to FIG. 7, a depth image sensing device 200 may generate depth data about a target object OBJ by using at least one depth sensing technology. The depth image sensing device 200 may include a light source module 210, a pixel array 220, a pixel driver 230, a timing controller 240, a pixel readout circuit 250, a TDC 260, and a processing unit 270.

The light source module 210 may emit a modulation light signal MLS to the target object OBJ in response to a control signal of the timing controller 240. The light source module 210 may be a laser diode (LD) emitting a light in a specific wavelength band (e.g. infrared rays or a visible light), a light emitting diode (LED), a near infrared laser (NIR), a point light source, a monochromatic light source in which a monochromator are combined with a white ramp, or a combination of other laser light sources. For example, the light source module 210 may emit an infrared light having a wavelength ranging from 800 nm to 1000 nm. The modulation light signal MLS may be a light pulse signal modulated to have a preset modulation characteristic (e.g., a waveform, a wavelength, a period, an amplitude, a frequency, a phase, or a duty rate).

The pixel array 220 may include a plurality of pixels arranged continuously in a two-dimensional matrix structure (e.g., arranged continuously in a row direction and a column direction). For example, the pixel array 220 may include unit pixels, each of which may include SPAD pixels.

Under control of the pixel driver 230, each of the pixels of the pixel array 220 may generate a pixel signal being an electrical signal corresponding to the intensity of a reflected modulation light signal MLS_R received through a lens module (not illustrated) by performing photoelectric conversion on the reflected modulation light signal MLS_R and may output the pixel signal to the pixel readout circuit 250.

Under control of the timing controller 240, the pixel driver 230 may generate a signal for controlling each of the pixels of the pixel array 220 and may supply the signal to the pixel array 220. In particular, the pixel driver 230 may generate a first modulation control signal and a second modulation control signal for controlling the timing at which each tap captures photo charges to be supplied to the pixel array 220.

The timing controller 240 may control all operations of the depth image sensing device 200 by controlling the light source module 210, the pixel driver 230, and the pixel readout circuit 250.

The pixel readout circuit 250 may process a pixel signal of an analog form output from each of the pixels and may generate depth data being digital data corresponding to a pixel signal. For example, the pixel readout circuit 250 may include an analog-to-digital converter for performing analog-to-digital conversion from the pixel signal to the depth data.

The TDC 260 may digitize the ToF and may generate a histogram based on the ToF, a ToF of laser pulses by the light source module 210, and count values of the laser pulses.

The processing unit 270 may perform the operation methods of the depth image sensing device described above. A configuration in which the processing unit 270 is independent of the TDC 260 is illustrated in FIG. 7. However, unlike FIG. 7, the processing unit 270 may be included in the TDC 260.

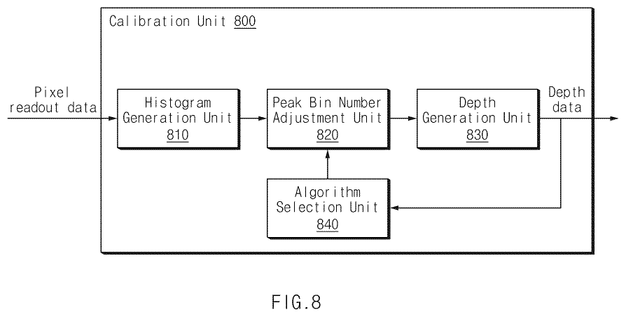

FIG. 8 is a block diagram of a calibration unit according to an example embodiment of the present disclosure.

Referring to FIG. 8, a calibration unit 800 according to an example embodiment of the present disclosure may include a histogram generation unit 810, a peak bin number adjustment unit 820, a depth generation unit 830, and an algorithm selection unit 840.

The calibration unit 800 may be a component which is included in the depth image sensing device according to an example embodiment of the present disclosure. For example, the calibration unit 800 may be included in the TDC 260 of the depth image sensing device 200, but the present disclosure is not limited thereto. The calibration unit 800 may be a component which performs calibration on SPAD pixels included in a unit pixel to reduce an error of depth measurement caused by the spatial variation between the SPAD pixels.

The histogram generation unit 810 may generate histograms based on laser pulses detected by the SPAD pixels included in the unit pixel. In detail, lasers emitted from a light source may be reflected by the object, and the SPAD pixels may detect the reflected lasers to generate a pixel signal. As the pixel signal is read out by a pixel readout circuit, pixel readout data may be generated. The histogram generation unit 810 may receive the pixel readout data to generate a histogram. The histogram generation unit 810 may generate histograms in which bin numbers corresponding to a ToF of laser pulses detected by the SPAD pixels are used as the x-axis and count values of the detected laser pulses are used as the y-axis. The histogram generation unit 810 may correspond to the above TDC.

The peak bin number adjustment unit 820 may adjust peak bin numbers of the histograms generated by the histogram generation unit 810. To improve the accuracy of depth measurement, the same depth needs to be generated by the SPAD pixels included in the unit pixel, but different depths may be generated by the variation in the SPAD pixels described above. The case where different depths are generated may mean the case where peak bin numbers of the generated histograms are different. Accordingly, the SPAD pixels may be calibrated by adjusting the different peak bin numbers. For example, the SPAD pixels may be calibrated by unifying the different peak bin numbers to a specific peak bin number, or the SPAD pixels may be calibrated by adjusting the different peak bin numbers to values within a given range. Multiple algorithms may be used for the peak bin number adjustment unit 820 to adjust the obtained peak bin numbers. For example, assuming that the histogram generation unit 810 already generates a first histogram, a second histogram, and a third histogram, at least one of a first peak bin number of the first histogram, a second peak bin number of the second histogram, and a third peak bin number of the third histogram may be different. In this case, an algorithm may be used which adjusts at least one of the first peak bin number, the second peak bin number, and the third peak bin number based on a peak bin number (the above target peak bin number) of a histogram corresponding to the greatest ratio among a first ratio of a peak value of the first histogram to the sum of count values of the first histogram, a second ratio of a peak value of the second histogram to the sum of count values of the second histogram, a third ratio of a peak value of the third histogram to the sum of count values of the third histogram.

Also, there may be used an algorithm which adjusts at least one of the first peak bin number, the second peak bin number, and the third peak bin number based on the greatest peak bin number (the above target peak bin number) among the first peak bin number, the second peak bin number, and the third peak bin number.

In addition, an algorithm may be used which adjusts at least one of the first peak bin number, the second peak bin number, and the third peak bin number based on the lowest peak bin number (the above target peak bin number) among the first peak bin number, the second peak bin number, and the third peak bin number. The methods described with reference to FIGS. 1, 4, 5A, and 5B may be used as a method of adjusting peak bin numbers based on a target peak bin number.

The depth generation unit 830 may generate depth data based on the adjusted peak bin numbers. For example, the depth generation unit 830 may generate the depth data by multiplying the speed of light and a ToF value corresponding to the adjusted peak bin number together.

The algorithm selection unit 840 may select an adjustment algorithm to adjust a peak bin number from among given algorithms based on the generated depths. In detail, assuming that algorithms capable of adjusting a peak bin number include a first algorithm, a second algorithm, and a third algorithm and assuming that first adjusted peak bin numbers adjusted through the first algorithm, second adjusted peak bin numbers adjusted through the second algorithm, third adjusted peak bin numbers adjusted through the third algorithm exist, the depth generation unit 830 may generate first depths, second depths, and third depths by using the first adjusted peak bin numbers, the second adjusted peak bin numbers, and the third adjusted peak bin numbers, respectively. The algorithm selection unit 840 may select an algorithm corresponding to depths being the closest to actual depth information (the ground truth information about the depth) from among the first depths, the second depths, and the third depths as the adjustment algorithm. For example, assuming that the first depths are the closest to the ground truth information about the depth, the algorithm selection unit 840 may select the first algorithm as the adjustment algorithm, and the peak bin number adjustment unit 820 may adjust the peak bin numbers by using the first algorithm. According to the above description, the peak bin number adjustment unit 820 may adjust the peak bin numbers through the optimal algorithm among the algorithms for adjusting the peak bin numbers. Accordingly, the depth generation unit 830 may generate an accurate depth compared to the case where any other algorithms are used.

To sum up, as the histogram generation unit 810 generates histograms by using detected laser pulses, the peak bin number adjustment unit 820 adjusts peak bin numbers of the histograms by using a plurality of algorithms, the depth generation unit 830 generates depths by using the adjusted peak bin numbers, the algorithm selection unit 840 determines a depth being the closest to actual depth information from among the generated depths and selects an algorithm used to generate the closest depth as an adjustment algorithm, the peak bin number adjustment unit 820 adjusts the peak bin numbers by using the adjustment algorithm selected by the algorithm selection unit 840, and the depth generation unit 830 generates the depth by using the adjusted peak bin numbers, the calibration unit 800 may have a feedback structure.

According to an example embodiment of the present disclosure, a depth image sensing device and an operation method thereof may calibrate a time-to-digital converter (TDC).

According to an example embodiment of the present disclosure, the depth image sensing device and the operation method thereof may measure a depth in consideration of the variation in single photon avalanche diode (SPAD) pixels constituting a unit pixel.

According to an example embodiment of the present disclosure, the depth image sensing device and the operation method thereof may adjust a peak bin number capable of being obtained from histograms associated with the SPAD pixels.

According to an example embodiment of the present disclosure, the depth image sensing device and the operation method thereof may increase depth accuracy.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An operation method of a depth image sensing device, the method comprising:
obtaining a first peak bin number from a first histogram generated by using a first single photon avalanche diode (SPAD) pixel included in a unit pixel and a time-to-digital converter (TDC);
obtaining a second peak bin number from a second histogram generated by using a second SPAD pixel included in the unit pixel and the TDC;
obtaining a third peak bin number from a third histogram generated by using a third SPAD pixel included in the unit pixel and the TDC; and
calibrating the TDC by adjusting at least one of the first peak bin number, the second peak bin number, and the third peak bin number.

2. The method of claim 1, wherein calibrating the TDC includes:
determining a target bin number, which is used as a criterion of adjusting peak bin numbers, based on the first peak bin number, the second peak bin number, and the third peak bin number; and
calibrating the TDC by adjusting at least one of the first peak bin number, the second peak bin number, and the third peak bin number based on the target bin number.

3. The method of claim 2, wherein determining the target bin number includes:
determining, as the target bin number, a peak bin number of a histogram corresponding to a ratio being the greatest from among a first ratio of a peak value of the first histogram to a sum of count values of the first histogram, a second ratio of a peak value of the second histogram to a sum of count values of the second histogram, and a third ratio of a peak value of the third histogram to a sum of count values of the third histogram.

4. The method of claim 2, wherein determining the target bin number includes:
determining the greatest peak bin number from among the first peak bin number, the second peak bin number, and the third peak bin number as the target bin number.

5. The method of claim 2, wherein determining the target bin number includes:
determining the lowest peak bin number from among the first peak bin number, the second peak bin number, and the third peak bin number as the target bin number.

6. The method of claim 2, wherein determining the target bin number includes:
obtaining ground truth information about a depth; and
determining a number of a bin, which should have a peak value in a histogram, as the target bin number, based on the ground truth information.

7. The method of claim 2, wherein calibrating the TDC includes:
calibrating the TDC by adjusting at least one of the first peak bin number, the second peak bin number, and the third peak bin number such that the first peak bin number, the second peak bin number, and the third peak bin number are equal to the target bin number.

8. The method of claim 2, wherein calibrating the TDC includes:
generating calibration values to be used to adjust peak bin numbers based on the target bin number; and
calibrating the TDC by adjusting at least one of the first peak bin number, the second peak bin number, and the third peak bin number based on the calibration values.

9. The method of claim 8, wherein generating the calibration values includes:
obtaining an adjustment unit value being a unit value for adjusting the peak bin numbers;
generating first calibration values by subtracting each of the first peak bin number, the second peak bin number, and the third peak bin number from the target bin number;
generating second calibration values by dividing the first calibration values by the adjustment unit value and removing decimals of result values of the division; and
generating third calibration values by multiplying the second calibration values and the adjustment unit value together.

10. The method of claim 9, wherein calibrating the TDC includes:
calibrating the TDC by adding the third calibration values to the first peak bin number, the second peak bin number, and the third peak bin number such that peak bin numbers are adjusted.

11. The method of claim 1, wherein obtaining the first peak bin number includes:
generating the first histogram in which a count value of laser pulses detected by the first SPAD pixel is used as a y-axis and bin numbers corresponding to a time of flight (ToF) of the laser pulses are used as an x-axis.

12. The method of claim 11, wherein generating the first histogram includes:
generating a coarse histogram in which the count value of the laser pulses is used as the y-axis and the bin numbers corresponding to the ToF of the laser pulses are used as the x-axis; and
generating the first histogram being a fine histogram by dividing an interval from a first bin number being a number of a bin having a peak value in the coarse histogram to a second bin number being a next number of the first bin number into given sections.

13. The method of claim 1, wherein each of the first peak bin number, the second peak bin number, and the third peak bin number is a number of a bin having a peak value in each of the first histogram, the second histogram, and the third histogram, respectively.

14. A depth image sensing device comprising:
a histogram generation unit configured to generate histograms based on laser pulses detected by single photon avalanche diode (SPAD) pixels included in a unit pixel;
a peak bin number adjustment unit configured to adjust peak bin numbers of the histograms by using at least one of given algorithms;
a depth generation unit configured to generate depths by using the adjusted peak bin numbers; and
an algorithm selection unit configured to select an adjustment algorithm for adjusting the peak bin numbers from among the given algorithms based on the depths.

15. The depth image sensing device of claim 14, wherein the peak bin number adjustment unit is configured to:
adjust the peak bin numbers to first adjusted peak bin numbers by using a first algorithm among the given algorithms; and
adjust the peak bin numbers to second adjusted peak bin numbers by using a second algorithm among the given algorithms,
wherein the depth generation unit is configured to:
generate first depths by using the first adjusted peak bin numbers; and
generate second depths by using the second adjusted peak bin numbers, and
wherein the algorithm selection unit is configured to select, as the adjustment algorithm, an algorithm corresponding to depths being closer to ground truth information about a depth from among the first depths and the second depths.

16. The depth image sensing device of claim 15, wherein the peak bin number adjustment unit is configured to adjust the peak bin numbers by using the selected adjustment algorithm.

17. The depth image sensing device of claim 14, wherein the histograms include a first histogram, a second histogram, and a third histogram,
wherein the peak bin numbers include a first peak bin number of the first histogram, a second peak bin number of the second histogram, and a third peak bin number of the third histogram, and
wherein the given algorithms include an algorithm configured to:
adjust at least one of the first peak bin number, the second peak bin number, and the third peak bin number based on a peak bin number (the above target peak bin number) of a histogram corresponding to a ratio being the greatest from among a first ratio of a peak value of the first histogram to a sum of count values of the first histogram, a second ratio of a peak value of the second histogram to a sum of count values of the second histogram, a third ratio of a peak value of the third histogram to a sum of count values of the third histogram.

18. The depth image sensing device of claim 14, wherein the histograms include a first histogram, a second histogram, and a third histogram,
wherein the peak bin numbers include a first peak bin number of the first histogram, a second peak bin number of the second histogram, and a third peak bin number of the third histogram, and
wherein the given algorithms include an algorithm configured to:
adjust at least one of the first peak bin number, the second peak bin number, and the third peak bin number based that a peak bin number being the greatest from among the first peak bin number, the second peak bin number, and the third peak bin number.

19. The depth image sensing device of claim 14, wherein the histograms include a first histogram, a second histogram, and a third histogram,
wherein the peak bin numbers include a first peak bin number of the first histogram, a second peak bin number of the second histogram, and a third peak bin number of the third histogram, and
wherein the given algorithms include an algorithm configured to:
adjust at least one of the first peak bin number, the second peak bin number, and the third peak bin number based on the lowest peak bin number from among the first peak bin number, the second peak bin number, and the third peak bin number.

20. A depth image sensing device comprising:
a pixel array including a unit pixel including a first single photon avalanche diode (SPAD) pixel, a second SPAD pixel, and a third SPAD pixel;
a time-to-digital converter (TDC) configured to digitize a time of flight of laser pulses detected by the first SPAD pixel, the second SPAD pixel, and the third SPAD pixel and to generate a first histogram associated with the first SPAD pixel, a second histogram associated with the second SPAD pixel, and a third histogram associated with the third SPAD pixel, based on the TOF of the laser pulses and count values of the laser pulses; and
a processing unit configured to calibrate the TDC by adjusting at least one of a first peak bin number of the first histogram, a second peak bin number of the second histogram, and a third peak bin number of the third histogram.
